(19) United States
(12) Patent Application Publication
(10) Pub. No.: US 2005/0031356 A1
(43) Pub. Date: Feb. 10, 2005

(54) Optical module

(76) Inventors: Mikiya Suzuki, Tokyo (JP); Shigeru Shikii, Tokyo (JP)

Correspondence Address: CANTOR COLBURN LLP, 55 Griffin Road South, Boomfield, CT, 06002, US

(21) Appl. No.: 10/667,057

(22) Filed: Sep. 22, 2003

Related U.S. Application Data
(60) Provisional application No. 60/413,535, filed on Sep. 24, 2002.

(51) Int. Cl. H04B 10/12

(52) U.S. Cl. 398/149

(57) ABSTRACT

An optical module 1 comprises an inlet side optical fiber, an optical filter optically connected to the inlet side optical fiber, and an outlet side optical fiber optically connected to the optical filter, wherein, the optical filter comprises a gain-slope compensation optical filter to flatten a gain slope (dG/dλ, where G:gain, λ:wavelength)of a gain of an optical amplifier connected to the inlet side optical fiber or the outlet side optical fiber. An optical amplifying module comprises an optical amplifier with the above-mentioned optical module 1. An optical transmission system comprises the optical module 1, an optical amplifier and an optical branching means, wherein FDM (Frequency Division Multiplexing) signal is branched and transmitted.

### CROSS-REFERENCE TO RELATED APPLICATIONS

The present application claims the benefit of the dates of the earlier filed provisional application, having U.S. Provisional Application No. 60/413,535 filed on Sep. 24, 2002, all of which are incorporated herein their entirety.

### BACKGROUND OF THE INVENTION

1. Field of Invention

The present invention relates to an optical amplifier, which is used in an optical communication system that transmits a signal of frequency division multiplexing (FDM), and a flattening of the gain-slope when amplified.

2. Related Art

A video distribution system, which transmits optical signals that are frequency-division-multiplexed digital or analogue signals and distributes multi-channels of video signals to plurality of subscribers distributed with the star coupler, has been put to practical use now.

In this system, there is necessity to compensate the optical branching loss because the loss of power occurs in distribution and transmission, erbium doped optical fiber amplifier (EDFA) is widely applied to compensate it.

For the application of erbium doped optical fiber amplifier (EDFA) to the video distribution system for the subscribers, details are described in IEEE/JLT, vol. 11, no. 1, and pp. 128-137, 1993, E. Yoneda and et al.

In general, two means of which is a direct modulation that directly modulated electric signals to semiconductor lasers etc. that are signal light sources, and an external modulation that controls intensity of optical signals launching form a light source with constant optical output by applying electric signals to external modulator, are known as means of generating optical signals.

The system using direct modulation means can be composed comparatively cheaply.

However, the problem that the oscillation wavelength becomes a little unstable, which is called Chirp in general, occurs by modulating the semiconductor laser itself.

Therefore, it is necessary to solve this problem of Chirp to apply the direct modulation means to high-speed modulation.

On the other hand, the external modulation excels in Chirp characteristic and is possible to apply to high-speed modulation.

At the same time, since it is necessary to set up an external modulator outside of the laser source, there is a problem on the cost.

It is general to use the direct modulation means as a signal light source for the advantage to exist in the cost under the present situation from such viewpoints.

In such an optical communication system, range of ±10 nm in center wavelength occurs under the specification of the light source used as a signal light source by a problem of manufacturing.

Though a light source, which has a range of about ±5 nm in center wavelength, actually can be prepared, the center wavelength might shift to about ±10 nm that is the above-mentioned specification because there is a difference.

In this case, it is convenient for system that erbium doped fiber amplifiers (EDFA), which are the transmission devices, have wide tolerance to wavelength.

Moreover, it is advantageous on the cost that erbium doped fiber amplifiers have wide range in wavelength because wavelength of semiconductor laser need not be selected.

In addition, a transmission means, which wavelength division multiplexes signals that are frequency-division-multiplexed, is designed; in this case, wide wavelength range is also desired.

However, a problem, which applicable wavelength range of signal light is restricted because signal distortion is easily generated by interaction with wavelength dependent gain (gain-slope ) due to big Chirp of signal light, occurs in the case of using signal light source of direct modulation means.

This point is indicated in K. Kikushima, IEEE/PTL, vol.3, no.10, pp.945-947, 1991.

This signal distortion can be expressed by the second order distortion (Composite second-order distortion: CSO).

The relations among this second distortion (CSO), the gain-slope of erbium doped optical fiber amplifier (EDFA), and Chirp of the signal light can be shown by following expression (1).

The number of uniting waves of the same channel of the second order distortion is assumed to be K, the gain of the erbium doped optical fiber amplifier (EDFA) is assumed to be G, the wavelength of signal is assumed to be λ, the signal wavelength of light source is assumed to be λ0, and the wavelength bandwidth of Chirp per channel is assumed to be,chirp, CSO is shown in expression (1), it is understood that the smaller gain-slope dG/dλ is, the less the signal distortion is.

$$CSO = 20 log \{ K \cdot \frac{1}{G} \cdot \frac{ⅆ G}{ⅆ λ} {\vert}_{λ = λ 0} \cdot {λ}_{chirp} \} [ dB ] \qquad expression ( 1 )$$

When the amount of the distortion which can be usually allowed in an analog system is converted into the gain-slope, it is necessary that the total of the gain-slope of all amplifiers which exist in the transmission line is about ±0.6 dB/nm or less (0.6 dB/nm or less in the absolute value) though it depends on the amount of Chirp of the signal light source.

Therefore, when the amplifiers of two stages are connected as shown in FIG. 7 for instance, the amount of the gain-slope allowed per one amplifier is about ±0.3 dB/nm or less (0.3 dB/nm or less in the absolute value).

Thus, there is a means of applying erbium doped optical fiber (EDF) to which aluminum (Al) is in a high density doped to the amplification medium of erbium doped optical fiber amplifier (EDFA) as one of the control means, though it is necessary to control the gain-slope of erbium doped optical fiber amplifier (EDFA) to control the signal distortion.

This is a use of the known characteristic that the wavelength dependency of the amplification characteristic (gain-slope) decreases when aluminum (Al) is doped in a high density to the erbium doped optical fiber (EDF).

As one example, the wavelength characteristic of the gain-slope of which using conventional equipment configuration is shown in FIG. 9 when erbium doped optical fiber (EDF) wherein aluminum (Al) is doped in a high density is applied to erbium doped optical fiber amplifier (EDFA) to suppress small the gain-slope of erbium doped optical fiber amplifier.

This figure is a result of evaluating the gain-slope of erbium doped optical fiber amplifier (EDFA) when input signal wavelength and input signal optical power of the FDM signal (No WDM signal) of 1 ch input to an analog amplifier are changed respectively.

The vertical axis in the graph is gain-slope (dB/nm), and a horizontal axis is wavelength (nm).

It is necessary to be careful that the gain characteristic of erbium doped optical fiber amplifier has wavelength dependency, which is not constant always but change by the input signal optical power that is input to the amplifier.

Therefore, the warrantable range in operation of erbium doped optical amplifier in an analogue optical transmission system is limited to the range within the value wherein the gain-slope is permitted in the system among the amplification characteristics which change depending on input signal optical power and the input wavelength condition to erbium doped optical fiber amplifier (EDFA).

Actually, the range where the amount of the gain-slope of 0.3 dB/nm or less is selected not to generate the signal distortion due to amplification of analog signal under the condition of which is obtained by input signal power and wavelength those are possible for EDFA to amplify.

The gain-slope changes from about +0.4 dB/nm to −0.9 dB/nm as shown in FIG. 9 when assuming the input dynamic range of 10 dB in this system.

However, when this amplifier is applied to the analogue transmission system as the above-mentioned, it is not possible to use it in all these input range.

Only 5 nm range of 1554-1559 nm can be used in this amplifier because the range of 0.3 dB/nm in the absolute value can be applied when the model of the system of two stages amplification is considered.

Therefore, if erbium doped optical fiber (EDF), which is doped aluminum (Al) in a high density, is applied, it is possible to make the gain-slope minimum in a certain condition of input signal optical power or the input wavelength.

However, it is principally impossible in all input signal optical power and the input wavelength condition to suppress the gain-slope in the level that is as low as suitable for practical use.

On the other hand, for the purpose of reducing a wavelength dependency of a gain (gain profile), there are similar optical filters such as gain flattening filters (GFF) in order to achieve a gain flattening characteristic of the WDM amplifier.

Those filters are designed the wavelength profile of transmittance to equalize the gain of each wavelength of wavelength division multiplexing (WDM) signal, such as Fiber Brag Grating (FBG) and the dielectric multi-layer film filter are used.

It is allowed even if there is some ripples in an amplitude of a loss characteristic for gain flattening filter (GFF), because the desired profile is almost a reverse-characteristic of the wavelength division multiplexing gain characteristic (The unit: dB) and it only has to satisfy the required flatness from the system side.

Therefore, such filters are not suitable for this application since it ends up that distortion has been generated unnecessarily when there is steep gain slope due to ripple and excessive negative-slope in it.

### SUMMARY OF THE INVENTION

Therefore, the purpose of this invention is enabling the communication in wide wavelength band by solving above-mentioned existing problem in the optical communication system to which applies an optical amplifier and suppressing the gain-slope. The inventors diligently researched to solve above-mentioned problem.

In consequent, an optical module that was difficult in prior arts of optical transmission system to which applied an optical amplifier, that suppresses gain-slope and enables drastic expansion of available wavelength band was found as described below.

In this invention, regardless of the condition of an input signal light power and an input signal wavelength, it becomes possible that a gain-slope is greatly suppressed compared with conventional one due to an optical module which combined optical amplifier, such as erbium doped optical fiber amplifier (EDFA) and a gain-slope compensation filter (GSCF).

As a result, an operation area (application area) of an amplifier is expanded, and a practical wavelength band, which is available to a telecommunication system, can be expanded.

Furthermore, an optical module of this invention is available no only to an optical distribution system but also to an optical output system and an optical input system, it is an optical module that can be applied to a variety of kinds of optical communication systems.

The first aspect of the optical module of the present invention comprises an optical module comprises an inlet side optical fiber, an optical filter optically connected to said inlet side optical fiber, and an outlet side optical fiber optically connected to said optical filter,
wherein, said optical filter comprises a gain-slope compensation optical filter to flatten a gain slope (dG/d λ, where G:gain, λ:wavelength) of a gain of an optical amplifier connected to said inlet side optical fiber or said outlet side optical fiber.

The second aspect of the optical module of the invention comprises an optical module, wherein said gain-slope compensation optical filter comprises a dielectric multi-layer film filter.

The third aspect of the optical module of the invention comprises an optical module, wherein said gain-slope compensation optical filter comprises a long-period fiber grating.

The fourth aspect of the optical module of the invention comprises an optical module, wherein said gain-slope compensation optical fiber is designed by using a gain-slope evaluation method according to a probe method.

The first aspect of the optical amplifying module of the invention comprises an optical amplifying module, wherein an optical amplifier and the optical module are optically connected.

The second aspect of the optical amplifying module of the invention comprises an optical amplifying module, wherein said optical amplifier comprises a rare earth doped optical fiber amplifier.

The third aspect of the optical amplifying module of the invention comprises an optical amplifying module, wherein an inlet side optical amplifier, an outlet side optical amplifier and one said optical module are included, and said optical module is arranged between said inlet side optical amplifier and said outlet side optical amplifier.

The first aspect of the optical transmission system of the invention comprises the optical module, an optical amplifier and an optical branching means, wherein FDM (Frequency Division Multiplexing) signal is branched and transmitted.

The second aspect of the optical transmission system comprises the optical module, an optical amplifier and an optical branching means, wherein FDM (Frequency Division Multiplexing) signal is further Wavelength Division Multiplexed to be branched and transmitted.

The third aspect of the optical transmission system of the invention comprises an optical transmission system, wherein said optical amplifier comprises a rare earth doped optical fiber amplifier.

The first aspect of the method for amplifying frequency modulated optical signal comprises a method, wherein there are employed an optical amplifying means and a gain-slope compensation means to flatten a gain slope of optical amplifying gain before or after an optical amplifying.

The second aspect of the method for amplifying frequency modulated optical signal comprises a method, wherein a dielectric multi-layer film filter is used as said gain-slope compensation means.

### BRIEF DESCRIPTION OF THE DRAWINGS

FIG. 1 is a schematic view showing elements of an embodiment of the gain-slope flattening module of the invention;

FIG. 2 is a figure wherein the instruments of the probe method evaluation system is shown;

FIG. 3(a) is a figure wherein the device structure of an optical module of this invention is shown; FIG. 3(b) is a figure wherein a gain-slope wavelength characteristic of an optical module of this invention is shown;

FIG. 4(a) is a figure wherein an equipment structure of a conventional optical amplification device is shown; FIG. 4(b) is a figure wherein a gain-slope wavelength characteristic of a conventional optical amplifier is shown;

FIG. 5 is a figure wherein gain-slope reverse-characteristic (Loss slope) calculated by the probe method is shown;

FIG. 6 is a figure wherein one example of loss profile (Loss profile) of a gain-slope compensation optical filter (GSCF) is shown;

FIG. 7 is a figure wherein an equipment arrangement of an optical communication system (embodiment 2), which amplifies in three stages, which apply an optical module of this invention, is shown;

FIG. 8 is a figure wherein an equipment arrangement of an embodiment (three stage amplification) of an optical communication system, which applies an optical module of embodiment 1, is shown; and

FIG. 9 is a figure of prior art wherein the wavelength characteristic of the gain-slope of erbium doped optical fiber amplifier (EDFA), which uses erbium doped optical fiber (EDF), which is doped aluminum (Al) in a high density, is shown.

### DETAILED DESCRIPTION OF THE INVENTION

Preferred embodiment of the invention is explained in detail with reference to the drawings.

(Gain-Slope Compensation Module)

Embodiments of the gain-slope compensation module are described in detail with reference to the drawings. The gain-slope compensation module 1 is an optical module in which an inlet optical fiber 2 and an outlet optical fiber 3 are optically connected to a gain slope compensation filter (GSCF) 4.

The invention is further described in detail. A gain-slope compensation filter (GSCF) 4, an inlet side collimator 5 and an outlet side collimator 6 are installed within a case 7. The gain-slope compensation filter is arranged between the inlet side collimator 5 and the outlet side collimator 6. The inlet side collimator 5 comprises a collimator lens 5a, a ferrule 5b , and a lens holder 5c. The inlet side fiber 2 is fixed in the ferrule 5b. The ferrule 5b is fixed to the lens 5a by means of the lens holder 5c so that the light outputted from the end of the fiber is collimated.

The outlet side collimator 6 also comprises a collimator lens 6a, a ferrule 6b, and a lens holder 6c. The outlet side fiber 3 is fixed in the ferrule 6b. The ferrule 6b is fixed to the lens 6a by means of the lens holder 6c so that the collimated light passing the collimator 5 is incident into the end surface of the fiber 3 by the collimator lens 6a.

The construction of the inlet side collimator 5, the outlet side collimator 6 may be those in which the inlet side fiber 2 and the collimator lens 5, as well as the outlet side fiber 3 and the collimator lens 6a are optically connected respectively, and are not limited to those shown in the above embodiments. For example, the ferrule 5b and the collimator lens 5a (the ferrule 6b and the collimator lens 6a) may be directly fixed, and the lens holders 5c, 6c may be divided into a plurality of components so that more fine adjustment and fixing can be effected.

When the gain-slope compensation module 1 is connected to the inlet side or the outlet side of the optical amplifier, the gain slope of the output light of the optical amplifier is flattened so as to enable to enlarge the operational range (application range) of the analog amplifier.

For example, when the gain-slope compensation module 1 is connected to the outlet side of the optical amplifier, the outputted light from the optical amplifier transmitted into the inlet side optical fiber 2, and entered into the gain-slope compensation optical filter 4 through the inlet side collimator 5. The signal light passing the gain-slope compensation filter 4 is transmitted into the outlet side optical fiber through the outlet side collimator 6 and further transmitted in the outlet side optical fiber. In the signal light outputted from the outlet side optical fiber, the gain slope (dG/d λ) is flattened by the gain-slope compensation optical filter in the wide wavelength band using the optical amplifier. As a result, as shown in an equation (1), CSO is suppressed so as to obtain an optical amplifier with small signal distortion in the wide wavelength band.

It is necessary to use a filter having an optical characteristics of little chirp as the gain-slope compensation filter (GSCF) 4. Accordingly, more specifically, it is considered that the dielectric multi-layer film filter is applied as the gain-slope compensation optical filter 4.

Furthermore, it is possible to use a long-period fiber grating in place of the dielectric multi-layer film filter. The fiber grating is formed in general by irradiating the ultra violet beam to the optical fiber to vary the reflective index of the optical fiber. The long-period fiber grating is those which pitch of the formed grating is within a range of 100 μm to 1000 μm. Since the wavelength dependency of the reflectivity in the long-period fiber grating is comparatively gradual, a ripple is hard to occur in the gain slope (dG/dλ), thus enable to obtain a flat gain slope (dG/dλ) compared to the short-period fiber grating. Furthermore, since the GSCF by the fiber grating is formed on the optical fiber, it is not necessary to have the collimator 5 or 6, thus enabling to provide a simple construction.

It is the most importance technical item to design (manufacture) the optical filter enabling to flatten the gain slope in the applied wavelength band in case that either filter may be used.

(A method for Designing (Manufacturing) the Gain-Slope Compensation Optical Filter(GSCF))

Then, an embodiment of the method for designing the gain-slope compensation optical filter is described in detail. In the embodiment, an erbium doped optical fiber amplifier (EDFA) is used as the optical amplifier.

(1) Measurement of Gain-Slope

In the case of inputting a signal light with Chirp to erbium doped optical fiber amplifier (EDFA), an inversion population of erbium doped optical fiber amplifier is decided according to the average wavelength of signal light without being influenced by Chirp because the response speed of erbium doped optical fiber amplifier (EDFA) is about ms.

On the other hand, the signal light is influenced by gain wavelength dependency (gain-slope) due to the extension of wavelength due to Chirp.

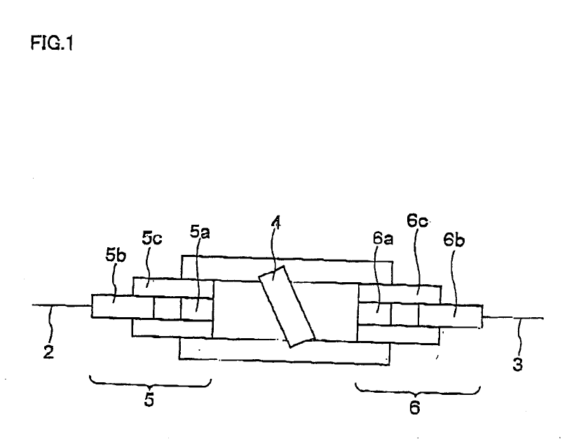

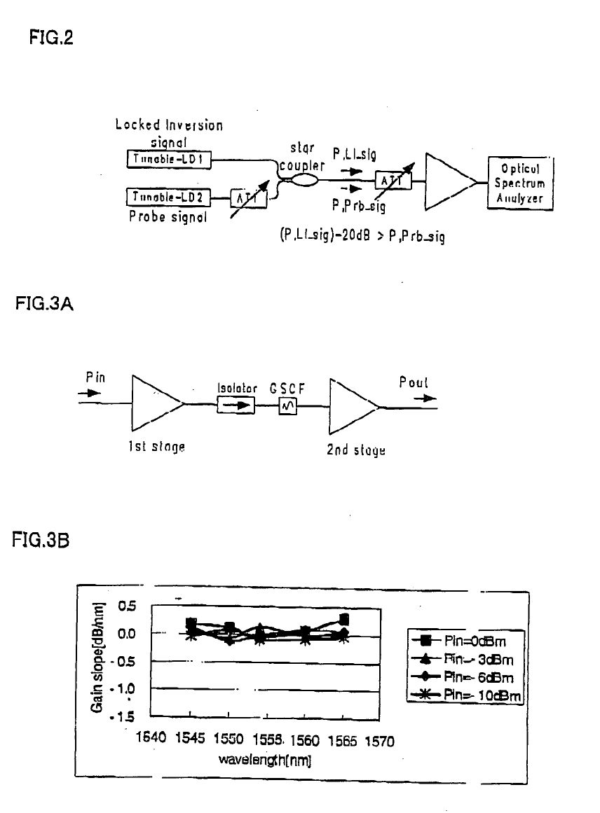

Therefore, by utilizing this, the gain-slope can be measured with the evaluation system shown in FIG. 1.

>Gain-Slope Evaluation Method (Probe Method)

The signal of wavelength equal to the signal to transmit the analogue signal is assumed to be Locked Inversion Signal. Against this, low signal optical power, which does not influence an amplification characteristic of an amplifier, is assumed to be Probe Signal.

It is preferable that the difference of the power level of Locked Inversion Signal and Probe Signal is about 20 dB or more.

These two signals are combined by Star Coupler and used as an input signal of an amplifier.

Locked Inversion Signal is set to prescribed wavelength because it is the signal which is actually applied frequency-division-multiplexed (FDM) carrier signals on.

Probe Signal is assumed to be swept at intervals of ± several nm centering on Locked Inversion Signal since it is a signal which evaluates LI (Locked Inversion) Gain of its neighborhood.

The input signal combined Locked Inversion Signal and Probe Signal, which is previously explained, is input to an erbium doped optical fiber amplifier (EDFA)

Wavelength dependent LI Gain generated on condition of population inversion, which is formed by sweeping this Probe Signal and inputting Locked Inversion Signal, is calculated by using expression (2) from Probe Signal.

$$LI Gain ( λ ) = \frac{Pout , prb ( λ ) - Pase , prb ( λ )}{Pin , prb ( λ )} [ dB ] \qquad ( 2 )$$

Here,

LI Gain(λ): LI Gain in each wavelength (dB)

Pin, prb(A): Input Probe signal power in each wavelength (dB m)

Pout, prb (A): Output Probe signal power in each wavelength (dB m)

Pase, prb (A): ASE (Amplified Spontaneous Emission) power of probe light in each wavelength (dBm)

(2) Calculation of Gain-Slope Reverse-Characteristic

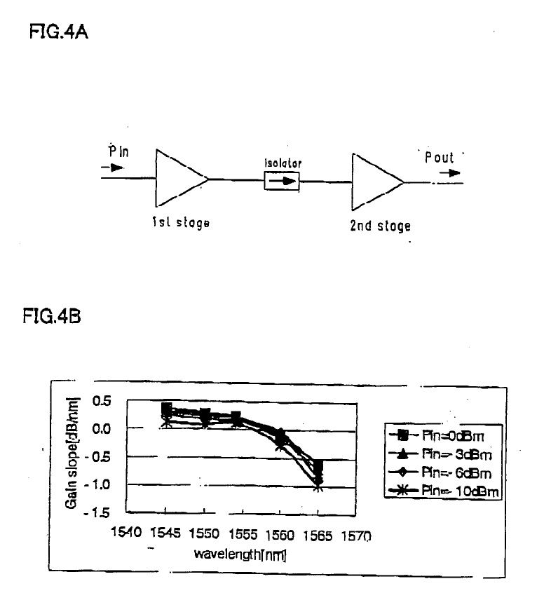

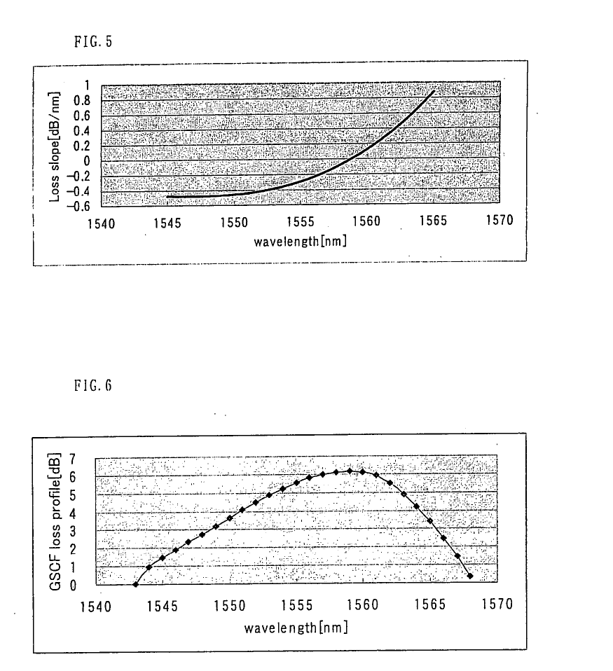

Next, wavelength dependent LI Gain (λ) that centers on prescribed wavelength is approximated in the second order function and reverse-characteristic of gain-slope (unit: dB/nm) of input signal wavelength calculated by first order differentiation is solved. Loss slope, which is reverse-characteristic of gain-slope such as showing the example in FIG. 4, is obtained by executing the calculation of the gain-slope in each wavelength.

Here, the vertical axis in the graph shows loss slope (dB/nm), and the horizontal axis shows wavelength (nm).

Because this loss slope (Loss slope) compensates the gain-slope (Gain-slope) of erbium doped optical fiber amplifier (EDFA), the profile of gain-slope compensation optical filter (GSCF), which reflects this result, is decided.

As a reference, one example of loss profile (Loss Profile) of gain-slope compensation optical filter (GSCF) is shown in FIG. 5.

Here, the vertical axis in the graph shows loss profile (dB), and the horizontal axis shows wavelength (nm).

Moreover, though this probe method is the most general as method of evaluating the gain-slope, and the most excellent method of obtaining an accurate value, it is also possible to use other methods.

Moreover, though the calculation of reverse-characteristic of the gain-slope is calculated by the first order differentiation of the quadratic function approximation in this invention, other function etc., which can approximate accurately an arbitrary gain-slope, may be used.

In this invention, an erbium doped optical fiber amplifier (EDFA) wherein a signal distortion is suppressed in a wider wavelength band can be obtained by analyzing a wavelength characteristic of the gain-slope to generate second order distortion (CSO), designing an optical filter which has a reverse-characteristic of a gain-slope to compensate for it and using this optical filter.

Therefore, if it satisfies described above, it is possible to take unprescribed methods other than above-mentioned methods or functions.

(Optical Amplifying Module of the Present Invention)

Now, a description will be given of an optical amplifying module, which employs an erbium-doped fiber amplifier (EDFA) as an optical amplifier, and in which a gain-slope compensation module of the present invention designed by the above-described method is connected to the EDFA.

This optical amplifying module is capable of making the gain slope (dG/dλ) of an erbium-doped fiber amplifier small. Therefore, it is possible to enlarge the operating range (application range) of an analog amplifier by applying the gain slope compensating filter (GSCF).

In this optical amplifying module, it is possible to combine one or a desired number (two or more) of optical amplifiers with one or a desired number (two or more) of gain slope compensating amplifiers. Methods for pumping optical amplifiers are a forward pumping method, a backward pumping method, and a bidirectional pumping method. In the three pumping methods, the gain-slope compensation module of the present invention can be connected.

A typical optical amplifying module is an optical amplifying module of two-stage amplification employing two optical amplifiers.

A preferred embodiment of the optical amplifying module of two-stage amplification is shown in FIG. 3A. The gain slope versus wavelength characteristics at different amounts of input power are shown in FIG. 3B. In this embodiment, the gain-slope compensation module is provided between the stages of optical amplification where it can be most effectively utilized, that is, between the optical amplifier of the first stage and the optical amplifier of the second stage.

Of course, the gain-slope compensation module may be provided at the input terminal of the optical amplifying module (input side of the optical amplifier of the first stage), or at the output terminal of the optical amplifying module (output side of the optical amplifier of the second stage). In these cases, the advantage of making the gain slop of the amplifier flat is also obtained.

However, in the optical amplifying module of two-stage amplification, if the loss of the gain slope compensating filter is L, the noise figure of the optical amplifier of the first stage is NF₁, the noise figure of the optical amplifier of the second stage is NF₂, and the gain of the optical amplifier of the first stage is G₁, the total noise figure NF total of the optical amplifying module is expressed as follows:

(1) When the gain-slope compensation module is installed at the input terminal of the optical amplifying module,
NFₜₒₜₐₗ=L+NF₁+NF₂/G₁
(2) When the gain-slope compensation module is installed between the optical amplifier of the first stage and the optical amplifier of the second stage,
NFₜₒₜₐₗ=NF₁+NF₂/(G₁−L)

When the gain-slope compensation filter is installed at the input side of the optical amplifier of the first stage, the loss L occurs as noise. However, when it is installed at the output side, no noise occurs.

Therefore, when the gain-slope compensation filter is installed between the optical amplifier of the first stage and the optical amplifier of the second stage, the noise figure NFₜₒₜₐₗ is significantly reduced compared to the case of (1) where it is installed at the input side. For instance, assuming the loss L of the gain-slope compensation filter is 3 dB and that the gain G1 of the optical amplifier is 20 dB, the third term on the right-hand side in the case of (1) and the second term on the right-hand side in the case of (2) are negligible because G1 is extremely great. As a result, the difference in NFₜₒₜₐₗ between (1) and (2) is the first term on the right-hand side in the case of (1), which is 3 dB. Note that as compared to the case of (1), the amplification efficiency in the case of (2) is reduced by the amount of the loss L, but it can be adjusted with the optical amplifier of the second stage.

(3) When the gain-slope compensation filter is installed at the output terminal, no noise occurs, but since the loss L of the gain-slope compensation filter has a direct influence on the final amplification, it reduces the output efficiency of the optical amplifying module.

Therefore, synthetically judging from the total noise figure and output efficiency of the optical amplifying module described above, it is found that the case of (2) where the gain-slope compensation filer is installed between the optical amplifier of the first stage and the optical amplifier of the second stage can be most effectively utilized.

However, there are cases where, depending on uses, it is preferable to apply the arrangement performed in the case of (1) or (3). In the optical amplifying module of the present invention, an optimum arrangement can be performed in all cases.

Now, the gain slope versus wavelength characteristic for the optical amplifying module of the present invention shown in FIG. 3A will be described compared with a conventional optical amplifying module that isn't applying the gain-slope compensation filter.

Initially, a conventional optical amplifying module not applying the gain-slope compensation filter is shown in FIG. 4A. The gain slope versus wavelength characteristic for the conventional optical amplifying module is shown in FIG. 4B.

As with the aforementioned case, in an optical communication system of two-stage amplification, the applicable range of the gain slope of one amplifier is 0.3 dB/nm.

Next, the gain slope versus wavelength characteristic for the optical amplifying module of the present invention will be compared with the gain slope versus wavelength characteristic for a conventional optical amplifying module.

As shown in FIG. 4B, in the conventional configuration, the usable frequency bandwidth is about 5 nm at most. However, in the configuration of the present invention, as shown in FIG. 3B, it can be confirmed that a satisfactory operation can be assured at a frequency bandwidth of 20 nm that is about 4 times that of the conventional configuration. Thus, the optical amplifying module of the present invention has the advantage of significantly increasing a usable frequency bandwidth.

While the above-described embodiment employs erbium-doped fiber amplifiers, the present invention is not to be limited to those amplifiers, but may employ other rare-earth doped fiber amplifiers. In addition, the amplification band is not limited to a C-band. For example, the present invention may employ an optical amplifier for amplifying an optical signal in the same pumping construction as an erbium-doped fiber amplifier, such as an amplifier employing tellurite, fluoride, or silicain the host glass there of, and an amplifier employing erbium, thulium, praseodymium, yttrium, terbium, or neodymium as dopant. Furthermore, the present invention can employ optical amplifiers of all kinds such as a semiconductor amplifier, etc.

(Optical Transmission System with the Gain-slope Compensation Module and Optical Amplifying Module of the Present Invention)

### EMBODIMENT 1

Referring to FIG. 8, there is shown one embodiment of an optical transmission system employing the gain-slope compensation module constructed in accordance with the present invention. This optical transmission system is a single-channel frequency-division multiplexing (FDM) transmission system, which splits and transmits an optical signal by employing a splitting device (splitting means) such as an optical coupler, etc. A compensation for the loss due to splitting is made with optical amplifiers (EDFA 1 to EDFA 3). Some or all of the optical amplifiers (EDFA1 to EDFA3) contain the gain-slope compensation module of the present invention shown in FIG. 1.

In this embodiment, amplifiers of three stages are connected in tandem, but this is merely an example. The number of amplifier stages may be any of 1 to n (where n is an integer), so long as the total of the gain slopes (dG/dλ) of optical amplifiers is within the required value of the system.

### EMBODIMENT 2

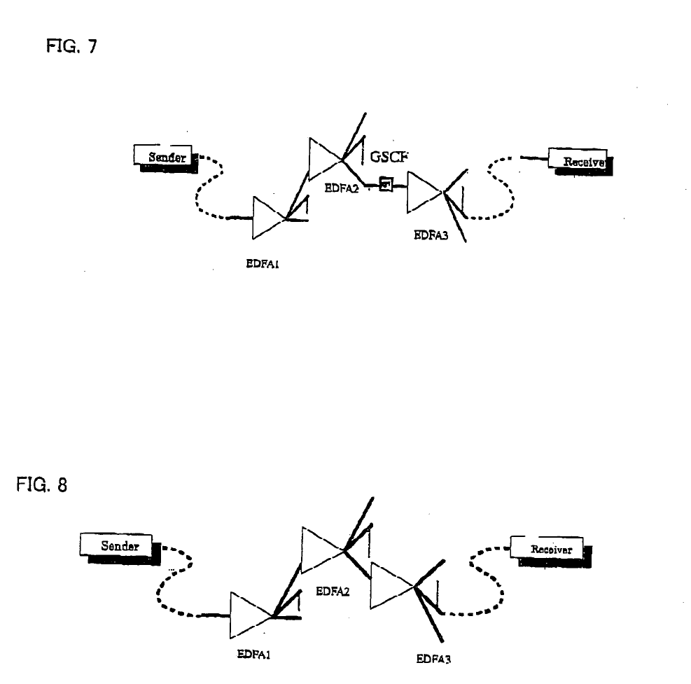

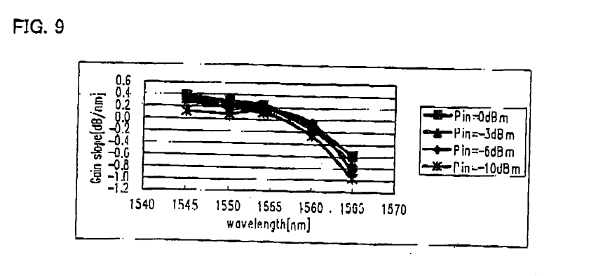

The gain-slope compensation module of the present invention does not always need to be installed in each optical amplifier. FIG. 7 shows an optical transmission system that splits the analog optical signal from a transmitter with a splitting device (splitting means) such as an optical coupler and sends the split signals to a plurality of receivers. A compensation for the loss due to splitting is made with an optical amplifier, which is an erbium-doped fiber amplifier (EDFA). For instance, this system is used to distribute CATV to customers.

In the optical transmission system shown in FIG. 7, it is not necessary to install the gain-slope compensation module in all of the optical amplifiers. As the figure shows, for the optical signal transmitted through a plurality of erbium-doped fiber amplifiers (EDFAs), a compensation for the gain slope (dG/dλ) can be made by providing the gain-slope compensation module at an arbitrary location between the transmitter and the receiver.

This embodiment may be referred to as an optical transmission system equipped with the gain-slope compensation module of the present invention. It can also be grasped-as a large optical amplifier module in which a plurality of erbium-doped fiber amplifiers are combined with the gain-slope compensation module.

In this embodiment, the gain slope characteristics of these erbium-doped fiber amplifiers are nearly the same. When the gain slope characteristics can be assumed, the inverse characteristic of the gain-slope compensation filter can be obtained by superposition of these gain slope characteristics.

In the case where the gain slope characteristics of erbium-doped fiber amplifiers differ from one another, the gain slope characteristics are measured by a method such as the aforementioned probe method, and then the gain slope inverse characteristic of the gain-slope compensation filter can be analyzed and designed.

The gain-slope compensation module, in addition to the position shown in FIG. 7, may be arranged at various positions. For example, the gain-slope compensation module may be arranged at the transmitter side to previously flatten the gain slope (dG/dλ) that cumulates. On the other hand, the gain-slope compensation module may be arranged at each receiver side to make the gain slope (dG/dλ) flat finally.

As set forth above, in the present invention, it is possible to provide the gain-slope compensation module of the present invention in an amplifier. It is also possible to provide the gain-slope compensation module of the present invention between amplifiers connected in tandem.

Furthermore, it is possible combine the optical modules of the two types. The number of amplifier stages may be any of 1 to n (where n is an integer) if the total of the gain slopes of amplifiers is within the requested value of the system.

The splitting means of an optical transmission system, in addition to employing optical couplers, is able to employ various splitting methods. For instance, an optical transmission system, in which optical amplifiers and the gain slope compensating of the present invention are combined in a metro-system, is also contained in one of embodiments of the present invention.

Thus, by employing the gain-slope compensation module of the present invention, a wider frequency bandwidth of an optical signal can be utilized in the optical amplifying module equipped with optical amplifiers such as erbium-doped fiber amplifiers, and in the optical transmission system equipped with erbium-doped fiber amplifiers and the gain-slope compensation module.

### OTHER EMBODIMENTS

In the above-described embodiments, although the application of the gain-slope compensation module and optical amplifying module of the present invention has been described with respect to the frequency-division multiplexing (FDM) in a single-channel transmission system, the gain-slope compensation module and optical amplifying module of the present invention can be likewise applied when a frequency-division-multiplexed (FDM) signal is further wavelength-division-multiplexed.

In the case of a single-channel system, even if a gain slope (dG/dλ) is not flat at a certain frequency bandwidth where the optical amplifier is used, output variations can be suppressed if an optical signal having a wavelength at which the gain slope (dG/dλ) is even is used. However, in the case of wavelength-division multiplexing (WDM), when amplifying two optical signals of different wavelengths, they struggle to take the energy of a single excitation light beam mutually. Therefore, if one of the two optical signals varies, the other optical signal also varies and the gain slope (dG/dλ) also varies. Therefore, in a conventional optical amplifying module having no gain-slope compensation filter (GSCF), the optical amplification in a WDM transmission system for a FDM signal is fairly difficult.

On the other hand, when applying the gain-slope compensation module and optical amplifying module of the present invention, the aforementioned problem will not occur, because the gain slope (dG/d λ) is flat in a wide wavelength band where the optical amplifiers are used. Thus, the optical amplification in a WDM transmission system for a FDM signal can be realized.

1. An optical module comprises an inlet side optical fiber, an optical filter optically connected to said inlet side optical fiber, and an outlet side optical fiber optically connected to said optical filter,
wherein, said optical filter comprises a gain-slope compensation optical filter to flatten a gain slope (dG/dλ, where G:gain, λ:wavelength)of a gain of an optical amplifier connected to said inlet side optical fiber or said outlet side optical fiber.

2. The optical module as claimed in claim 1, wherein said gain-slope compensation optical filter comprises a dielectric multi-layer film filter.

3. The optical module as claimed in claim 1, wherein said gain-slope compensation optical filter comprises a long-period fiber grating.

4. The optical module as claimed in claim 1, wherein said gain-slope compensation optical fiber is designed by using a gain-slope evaluation method according to a probe method.

5. An optical amplifying module comprises an optical amplifier with the optical module according to claim 1 being optically connected.

6. The optical amplifying module as claimed in claim 5, wherein said optical amplifier comprises a rare earth doped optical fiber amplifier.

7. The optical amplifying module as claimed in claim 5, wherein an inlet side optical amplifier, an outlet side optical amplifier and one said optical module are included, and said optical module is arranged between said inlet side optical amplifier and said outlet side optical amplifier.

8. An optical transmission system comprises said optical module of claim 1, an optical amplifier and an optical branching means, wherein FDM (Frequency Division Multiplexing) signal is branched and transmitted.

9. An optical transmission system comprises said optical module of claim 1, an optical amplifier and an optical branching means, wherein FDM (Frequency Division Multiplexing) signal is further Wavelength Division Multiplexed to be branched and transmitted.

10. The optical transmission system as claimed in claim 8, wherein said optical amplifier comprises a rare earth doped optical fiber amplifier.

11. A method for amplifying frequency modulated optical signal, wherein there are employed an optical amplifying means and a gain-slope compensation means to flatten a gain slope of optical amplifying gain before or after an optical amplifying.

12. The method as claimed in claim 11, wherein a dielectric multi-layer film filter is used as said gain-slope compensation means.
